(19) United States
(12) Patent Application Publication
(10) Pub. No.: US 2005/0075151 A1
(43) Pub. Date: Apr. 7, 2005

(54) Flip-top mobile phone

(76) Inventor: Kai-Chung Hou, Taipei City (TW)

Correspondence Address: RABIN & BERDO, P.C., Suite 500, 1101 14th Street, N.W., Washington, DC, 20005, US

(21) Appl. No.: 10/958,284

(22) Filed: Oct. 6, 2004

(30) Foreign Application Priority Data
Oct. 6, 2003 (TW) 92127718

(51) Int. Cl. H04M 1/00

(52) U.S. Cl. 455/575.3; 455/575.1

(57) ABSTRACT

A flip-top mobile phone including a main body and a lifting cover is disclosed. The main body has a first pivot section while a first device is disposed in the neighbor of the first pivot section within the main body. The lifting cover has a second pivot section. The lifting cover and the main body are able to rotate against each other via the pivotal connection formed by the first pivot and the second pivot. A second device is disposed in the neighbor of the second pivot section within the lifting cover but is opposed to the first device. At least one or both of the first device and the second device is magnetic, so that the first device and the second device approach each other and generate an attractive force when the lifting cover is rotated to a maximum angle of opening against the main body

This application claims the benefit of Taiwan application Serial No. 92127718, filed Oct. 6, 2003, the subject matter of which is incorporated herein by reference.

### BACKGROUND OF THE INVENTION

1. Field of the Invention

The invention relates in general to a mobile phone, and more particularly to a flip-top mobile phone.

2. Description of the Related Art

Along with the rapid advance in information and telecommunication technology, portable electronic devices which provide the users with great convenience are gaining greater and greater popularity. Taking the mobile phone for example, a compacter and smarter exterior design can be seen in both the conventional coverless mobile phone and the flip-top mobile phone as well.

Referring to FIG. 1, a schematic diagram of a flip-top mobile phone is illustrated. Flip-top mobile 10 has a main body 101 and a lifting cover 103, wherein the two parts are pivotally connected together via a pivot 105. When folded up, the flip-top mobile phone 10 stands by with a smaller size; when flipped open, the flip-top mobile phone is in use with its speaker and receiver being close to the user's mouth and ear respectively. Further, due to its various appealing and fashionable exterior designs, the flip-top mobile phone 10 has become a mainstream product in the market.

Most of the commonly seen flip-top mobile phones adopt a cam pivot design, which uses the cam configuration to enable the lifting cover to rotate against the main body until a maximum angle of opening has been reached. Meanwhile, in order to prevent the lifting cover from shaking when rotating is halted, normally a certain reserved torque is applied to the lifting cover after the maximum angle of opening has been reached so that the lifting cover may hold out against the main body firmly.

Referring to both FIG. 2A, a schematic diagram showing the status when the lifting cover has reached the maximum angle of opening against the main body, and FIG. 2B, a partial enlargement of FIG. 2A, at the same time. Pivot 105 reserves a torque that prevents the lifting cover 103 from shaking after having rotated to the maximum angle of opening against the main body 101. However, in order to reserve the torque in advance, a torque must be pre-applied to the pivot 105 before the lifting cover 103 is folded up with the main body 101. However, this will cause inconvenience to the assembly of the flip-top mobile phone 10.

Furthermore, if the pivot 105 generates an over-large torque, the lifting cover 103, which is flipped open along with the arrow direction shown in FIG. 2A, may cause the coating on the contact surface 107 between the main body 101 and the lifting cover 103 to peel off due to long term percussion.

### SUMMARY OF THE INVENTION

It is therefore an object of the invention to provide a flip-top mobile phone whose assembly is made simpler and easier. Meanwhile, the peeling off on the exterior coating of the above disclosed flip-top mobile phone is improved, allowing the flip-top mobile phone to maintain an attractive exterior.

It is therefore another object of the invention to provide a flip-top mobile phone being able to mitigate the percussive force, which the lifting cover applies onto the main body when the maximum angle of opening is reached.

It is another object of the invention to provide a flip-top mobile phone including a main body and a lifting cover. The main body has a first pivot section while a first device is disposed in the neighbor of the first pivot section within the main body. The lifting cover has a second pivot section. The lifting cover and the main body are able to rotate against each other via the pivotal connection formed by the first pivot and the second pivot. A second device is disposed in the neighbor of the second pivot section within the lifting cover but is opposed to the first device. At least one or both of the first device and the second device is magnetic, so that the first device and the second device approach each other and generate an attractive force when the lifting cover is rotated to a maximum angle of opening against the main body.

The above-disclosed flip-top mobile phone has two scenarios. Scenario one is that both the first device and the second device are magnetic. When the lifting cover is flipped open from the main body, a repulsive force, which is generated as the two devices gradually approach each other, mitigates the percussive force, which the lifting cover applies onto the main body when the maximum angle of opening is reached.

Another scenario may be one of the following cases: first, both the first and the second device are magnetic devices; second, the first device is a magnetic device but the second device is a magnetic-inductive device; third, the first device is a magnetic -inductive device but the second device is a magnetic device. When the lifting cover is flipped open from the main body, the first device and the second device approach each other and generate an attractive force to stabilize the lifting cover at the maximum angle of opening.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional flip-top mobile phone;

FIG. 2A is a schematic diagram showing the status when the lifting cover has reached the maximum angle of opening against the main body;

FIG. 2B, is a partial enlargement of FIG. 2A;

FIG. 3A is a sectional view of the main body of a flip-top mobile phone according to the preferred embodiment of the invention;

FIG. 3B a sectional view of the lifting cover of a flip-top mobile phone according to the preferred embodiment of the invention;

FIG. 4 is an assembly diagram of a flip-top mobile phone;

FIG. 5 is a scenario when the opposing two surfaces of the first device and the second device are of the same polarity; and

FIG. 6 is a scenario when the opposing two surfaces of the first device and the second device are of opposite polarities.

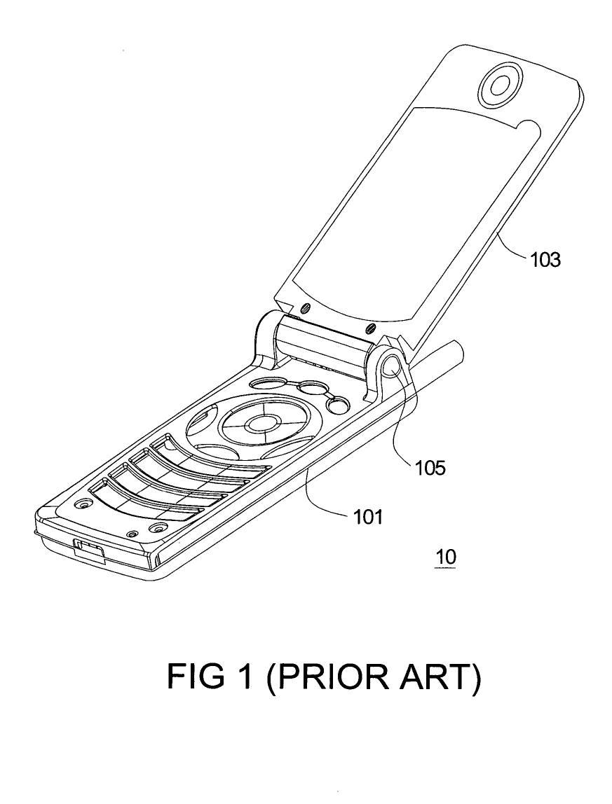

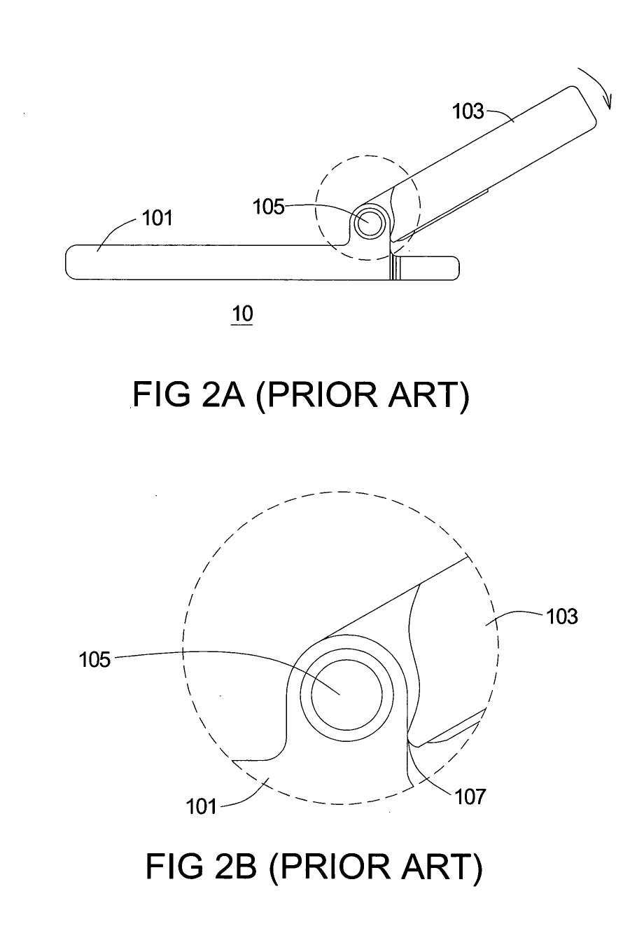

### DETAILED DESCRIPTION OF THE INVENTION

The invention is disclosed by way of a preferred embodiment. However, the preferred embodiment does not limit the scope of the invention. The technical characteristics of the invention are disclosed below.

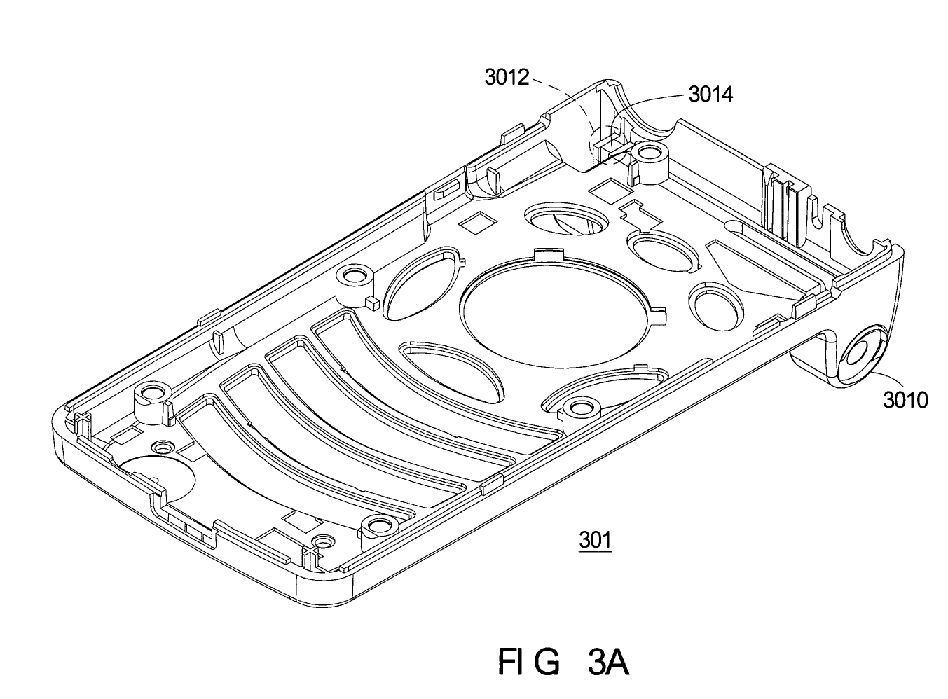

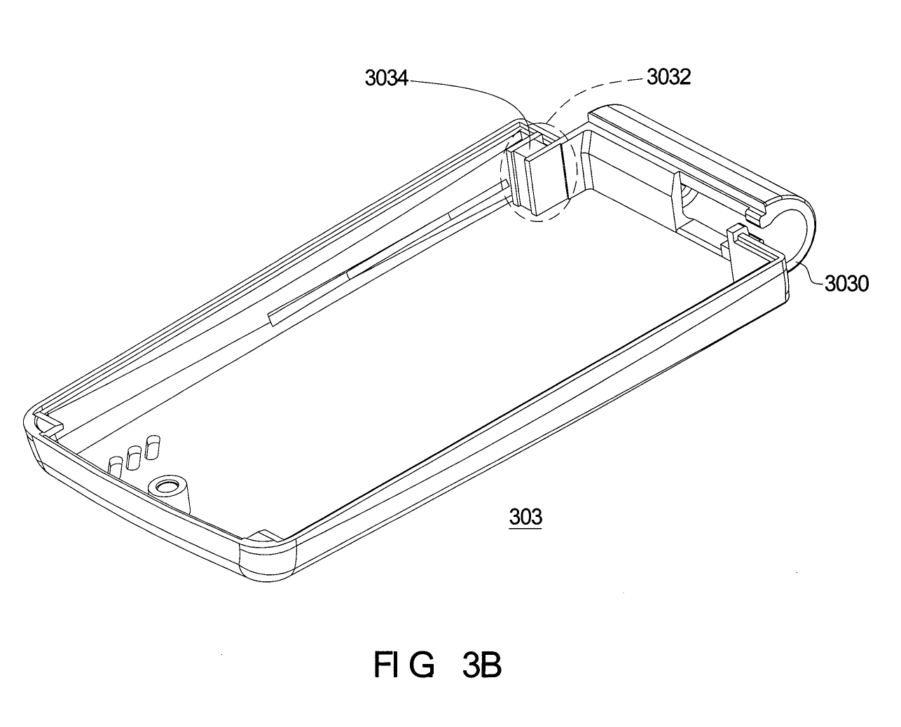

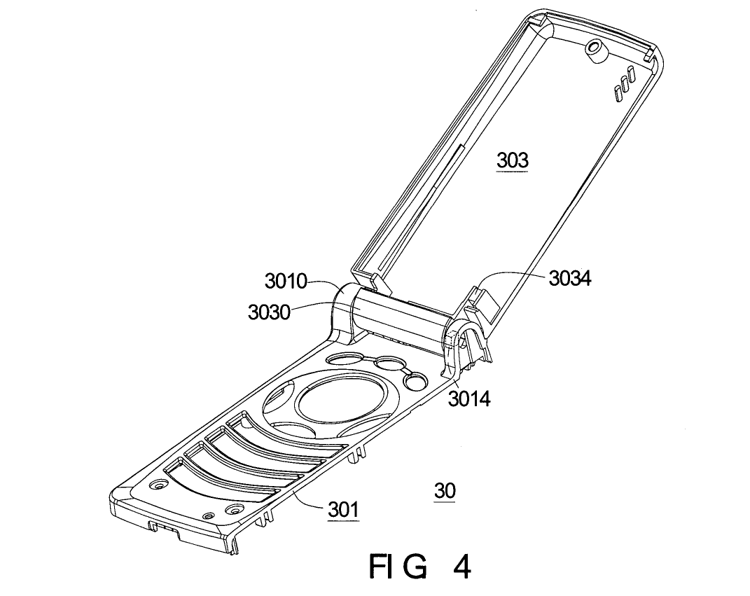

Referring to both FIG. 3A and FIG. 3B, FIG. 3A is a sectional view of the main body of a flip-top mobile phone according to the preferred embodiment of the invention, while FIG. 3B is a sectional view of the lifting cover of a flip-top mobile phone according to the preferred embodiment of the invention. The flip-top mobile phone mainly includes a main body 301 and a lifting cover 303.

Main body 301 as a part of the flip-top mobile phone incorporates other parts of the mobile phone to accommodate circuit boards and other electric devices. Moreover, the main body 301 may have exposed press-keys for the user's convenience. The main body 301 has a first pivot section 3010. And an installation section 3012 is disposed at a shoulder within the main body 301 near the first pivot section 3010.

The lifting cover 303 is for accommodating a display monitor and a receiver. The lifting cover 303 includes a second pivot section 3030. And a second installation section 3032 opposing the first installation section 3012 is at a shoulder within the lifting cover 310 near the second pivot section 3030. Moreover, a first device 3014 and a second device 3034, at least one of which is magnetic, are disposed at the first installation section 3012 and at the second installation section 3032 respectively.

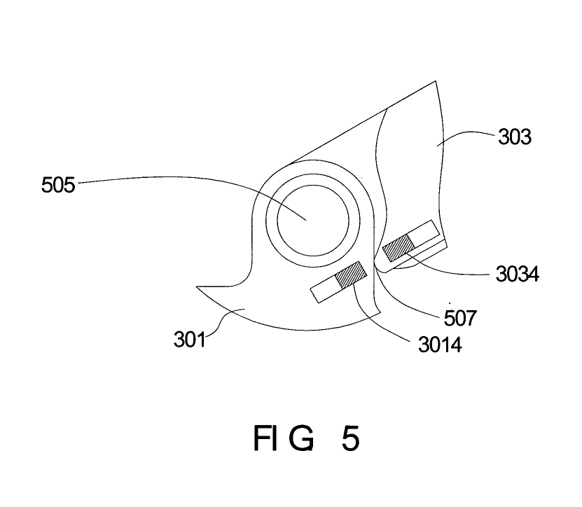

Referring to FIG. 4, an assembly diagram of a flip-top mobile phone is disclosed. Turn over the main body 301 as shown in FIG. 3A, the inner side of the main body 301 is shown in FIG. 4. The lifting cover 303 and the main body 301 may rotate against each other via the pivotal connection formed by the second pivot section 3030 and the first pivot section 3010. The dotted line shown in the assembled flip-top mobile phone 30 of FIG. 4 depicts the first device 3014 disposed at the inner side of the main body 301.

It can be seen in the diagram that the second device 3034 disposed at the inner side of the lifting cover 303 is opposed to the first device 3014 disposed at the inner side of the main body 301. When the lifting cover 303 is flipped open from the main body 301, the first device 3014 and the second device 3034 gradually approach each other and generate a magnetic force.

In the above flip-top mobile phone 30 according to the invention, the polarity of the first device 3014 and that of the second device 3034 may have two scenarios, which are disclosed below.

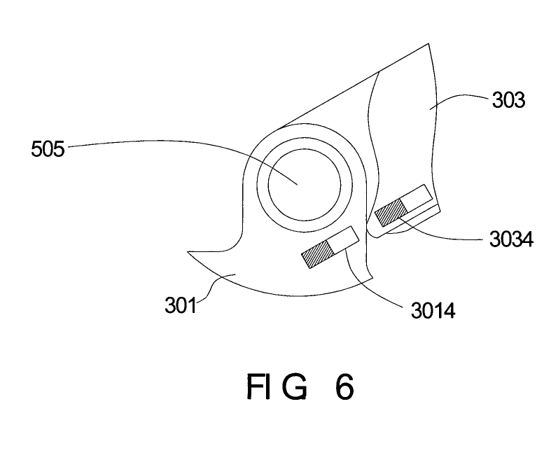

Referring to FIG. 5, when the opposing two surfaces of the first device and the second device are of the same polarity is shown. Both the first device 3014 and the second device 3034 are magnetic and opposing surfaces of the first device 3014 and the second device 3034 have the same polarity, say, N—N or S—S for instance.

When the lifting cover 303 is flipped open from the main body 301, the first device 3014 and the second device 3034 approach each other and generate a repulsive force. This repulsive force mitigates the percussive force which the lifting cover 303 applies onto the main body 301 when the lifting cover 303 is flipped open to the maximum angle of opening.

Referring to FIG. 6, a scenario when the opposing two surfaces of the first device and the second device are of opposite polarities. Under this circumstance, the first device 3041 and the second device 3034 may both be magnetic and opposing surfaces of the first device 3014 and the second device 3034 have opposite polarities, say, N—S or S—N for instance. Or the first device 3014 is a magnetic device while the second device 3034 is a magnetic-inductive device, say, iron, cobalt or nickel for instance. Or the second device 3034 is a magnetic device while the first device 3014 is a magnetic-inductive device, wherein the two devices attract each other as they approach each other.

When the lifting cover 303 is flipped open from the main body 301, the first device 3014 and the second device 3034 approach each other and generate an attractive force to stabilize the lifting cover at a maximum angle of opening.

As shown in FIG. 3A and FIG. 3B, the first installation section 3012 and the second installation section 3032 are not necessarily to be formed at a shoulder positioned at the inner side of the main body 301 and the lifting cover 303 respectively. That is to say, the first device 3014 and the second device 3034 simply need to be positioned at a position allowing an attractive force to be generated as the second device 3034 approaches the first device 3014 when the lifting cover 303 is flipped open. Further more, the respective disposition of the first device 3014 and the second device 3034 within the main body 301 and the lifting cover 303 does not need to be done via the first installation section 3012 and the second installation section 3032. Any method, which enables the first device 3014 and the second device 3034 to be fastened onto the main body 301 and the lifting cover 303 respectively, will do.

FIG. 5 and FIG. 6 only illustrate the relative location between the first device 3014 and the main body 301 and the relative location between the second device 3034 and the lifting cover 303. Any method, which enables the first device 3014 and the second device 3034 to be disposed within the main body 301 and the lifting cover 303 respectively and generates the abovementioned attractive force, is within the spirit of the invention.

It can be seen in FIG. 5, a repulsive force generated between the first device 3014 and the second device 3034 mitigates the torque generated by the pivot 505 to flip the lifting cover open. As a result, the lifting cover 303 will not cause severe percussion to the main body 301. And the coating on the contact surface 507 between the main body 301 and the lifting cover 303 will not peel off.

On the other hand, if the magnetic force between the first device 3014 and the second device 3034 is an attractive force as shown in FIG. 6 instead of a repulsive force as shown in FIG. 5, such attractive force will stabilize the lifting cover 303 at a maximum angle of opening. Therefore when assembling the lifting cover 303 and the main body 301 to form a flip-top mobile phone, the user does not need to pre-apply an over-large torque to the pivot 505. By means of the attractive force, the lifting cover 303 will not shake after having been flipped open from the main body 301 and having reached the maximum angle of opening. This indirectly facilitates the assembly of the flip-top mobile phone.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A flip-top mobile phone comprising at least:
a main body having a first pivot section, wherein a first device is disposed on the main body near the first pivot section; and
a lifting cover having a second pivot section, wherein the lifting cover and the main body are able to rotate against each other via a pivotal connection of the first pivot section and the second pivot section and a second device is disposed on the lifting cover near the second pivot section but opposite to the first device,
wherein at least one of the first device and the second device is magnetic and while the lifting cover is flipped open from the main body, the first device and the second device approach each other and a magnetic interaction is generated therebetween.

2. The flip-top mobile phone according to claim 1, wherein the first device and the second device are both magnetic devices and when the lifting cover is flipped open from the main body, the fist device and the second device approach each other and a repulsive force is generated to mitigate a percussive force the lifting cover applies onto the main body when a maximum angle of opening is reached.

3. The flip-top mobile phone according to claim 1, wherein the first device and the second device are both magnetic devices and when the lifting cover is flipped open from the main body, the first device and the second device approach each other and an attractive force is generated to stabilize the lifting cover at a maximum angle of opening.

4. The flip-top mobile phone according to claim 1, wherein the first device is a magnetic device and the second device is a magnetic-inductive device.

5. The flip-top mobile phone according to claim 1, wherein the first device is a magnetic-inductive device and the second device is a magnetic device

6. The flip-top mobile phone according to claim 1, wherein a first installation section and a second installation section are respectively formed within an inner side of the main body and an inner side of the lifting cover, and the first device and the second device are respectively disposed within the first installation section and the second installation section.
